(19) United States
(12) Patent Application Publication
(10) Pub. No.: US 2009/0303485 A1
(43) Pub. Date: Dec. 10, 2009

(54) Electronic Component Mounting Apparatus and Printed Circuit Board Processing Apparatus

(75) Inventors: Shigeru KURIBARA, Ota (JP); Zhehong Jin, Oizumi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Tech Instruments Co., Ltd.

(21) Appl. No.: 12/481,622

(22) Filed: Jun. 10, 2009

(30) Foreign Application Priority Data
Jun. 10, 2008 (JP) 2008-151509

(51) Int. Cl. G01N 21/00

(52) U.S. Cl. 356/432

(57) ABSTRACT

An electronic component mounting apparatus or a printed board processing apparatus is provided which can reliably detect positioning of a board in a position for having a component mounted thereon and further detect transferring of the board to a predetermined position, thereby contributing toward productivity improvement. To detect transferring of a board, light is transmitted from a light transmitting section to hit an end portion of the board. To detect positioning of the board, a light receiving section is optically blocked by the board.

### BACKGROUND OF THE INVENTION

The present invention relates to an electronic component mounting apparatus and a printed board processing apparatus, and more particularly, to an electronic component mounting apparatus and a printed board processing apparatus which can reliably transfer a printed board to a position for having an electronic component mounted on the printed board.

In an electronic component mounting apparatus or a printed board processing apparatus, it is important that a printed board (hereinafter also referred to as a “board”) be transferred to a predetermined position and that the printed board be reliably set in a position for having an electronic component (hereinafter also referred to simply as a “component”) mounted thereon. In existing board detection methods, light is emitted from below to a board and the light reflected from the board (reflection-based method) or the light passing through the board (transmission-based method) is detected by a photodetector to determine the presence of the board (see JP-A No. 2003-174282, for example).

### SUMMARY OF THE INVENTION

There are, however, problems with such existing methods, whether reflection-based or transmission-based ones. Detection errors, for example, are among the problems. FIGS. 9A and 9B are diagrams for explaining an existing method of board detection. FIG. 9A is a plan view of a transfer section for transferring a board P. FIG. 9B is a side view of the transfer section as seen in the direction in which the board P is transferred. When the board P has a cutout portion 9a or a hole 9b as shown in FIG. 9A, light emitted to the cutout portion 9a or hole 9b passes through such a portion without being detected by a reflection sensor 29 and results in being detected in a transmission type detection system having a light transmitting section 31 and a light receiving section 33. In this case, it is erroneously determined that the board P is not present. In cases where a reflection type detection system is used, detection errors can occur depending on the color or material of the board.

Two types of board detection are performed. They are (1) board transfer detection in which a board which has been transferred to a predetermined position is detected and (2) board positioning detection in which a board which has been set, after being transferred to the predetermined position, in a component mounting position for having a component mounted thereon is detected. In the case of (1) board transfer detection, when a board having a cutout portion or a hole is transferred, the cutout portion or the hole also moves, so that the board can be detected. In the case of (2) board positioning detection, the board to be detected is at rest, so that, if a detection error is caused by a cutout portion or a hole formed in the board to be detected, the error is not canceled. Coping with such a situation requires extra time, so that productivity decreases. It is therefore important that board positioning detection can be performed with high reliability.

In cases where a reflection type detection system is used, a detection error results if light emitted to detect a board is reflected by an electronic component 28 held by a suction nozzle standing by above the board transfer section so as to mount the electronic component 28 on a board or by a mounting head 16 thereby allowing the light receiving section 33 to receive the reflected light. This can be avoided by having the electronic component 28 stand by in a position not to reflect the light, but doing so will result in decreasing productivity.

The present invention provides an electronic component mounting apparatus having a board detection unit which can reliably detect board positioning to thereby contribute toward productivity improvement.

The present invention also provides an electronic component mounting apparatus and a board processing apparatus which can reliably detect a board transfer to thereby contribute toward productivity improvement.

An electronic component mounting apparatus according to the present invention includes a printed board detection unit which detects that a printed board has been transferred, by a pair of transfer parts provided along both side end portions thereof, to a predetermined position and that the printed board has been set in a component mounting position for having an electronic component mounted thereon. In the electronic component mounting apparatus, the printed board detection unit includes a light transmitting section which transmits light, a light receiving section which receives light, and an optical repeater section which is positioned to face, across the printed board, the light transmitting section and the light receiving section and which retransmits the light received from the light transmitting section, either the light transmitting section or the light receiving section and the optical repeater section being positioned between the component mounting position and the position to which the printed board is transferred.

An electronic component mounting apparatus according to the present invention includes a printed board detection unit which detects that a printed board has been transferred, by a pair of transfer parts provided along both side end portions thereof, to a predetermined position and that the transferred printed board has been set in a component mounting position for having an electronic component mounted thereon. In the electronic component mounting apparatus: the printed board detection unit includes a light transmitting section which transmits light, a light receiving section which receives light, and an optical repeater section which is positioned to face, across the printed board, the light transmitting section and the light receiving section and which retransmits the light received from the light transmitting section; and, when the printed board is in the predetermined position, the transmitted light hits an end portion of the printed board and, when the printed board is set in a component mounting position for having an electronic component mounted thereon, the light retransmitted by the optical repeater section is blocked by the printed board.

An electronic component mounting apparatus according to the present invention has a printed board positioning detection unit which detects that a transferred printed board has been set in a component mounting position for having an electronic component mounted thereon. In the electronic component mounting apparatus, the printed board positioning detection unit includes a light transmitting section which transmits light and a light receiving section positioned to face, across the printed board, the light transmitting section, the light transmitting section and the light receiving section being provided in an area between the component mounting position and a surface over which the printed board is transferred.

A printed board processing apparatus according to the present invention includes a detection unit which detects that a printed board has been transferred, by a pair of transfer parts provided along both side end portions thereof, to a predetermined position. In the printed board processing apparatus, the detection unit includes a light transmitting section which transmits light and a light receiving section which receives light, the light receiving section being positioned to face, across the printed board, the light transmitting section such that light transmitted from the light transmitting section hits a side end portion of the printed board.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a plan view of an automatic electronic component mounting apparatus;

FIGS. 2A and 2B schematically illustrate the configuration of a board transfer line;

FIGS. 3A and 3B illustrate an example of board transfer detection performed by a board position detection sensor;

FIGS. 4A and 4B illustrate an example of board positioning detection performed by a board position detection sensor;

FIG. 5 illustrates a light transmitting section and a light receiving section of a board sensor according to a first embodiment of the invention;

FIG. 6 illustrates an optical repeater section of the board sensor according to the first embodiment of the invention;

FIG. 7 illustrates an optical repeater section according to a second embodiment of the invention;

FIG. 8 illustrates an optical repeater section according to a third embodiment of the invention; and

FIGS. 9A and 9B illustrate an existing method of board detection.

### DESCRIPTION OF THE PREFERRED EMBODIMENTS

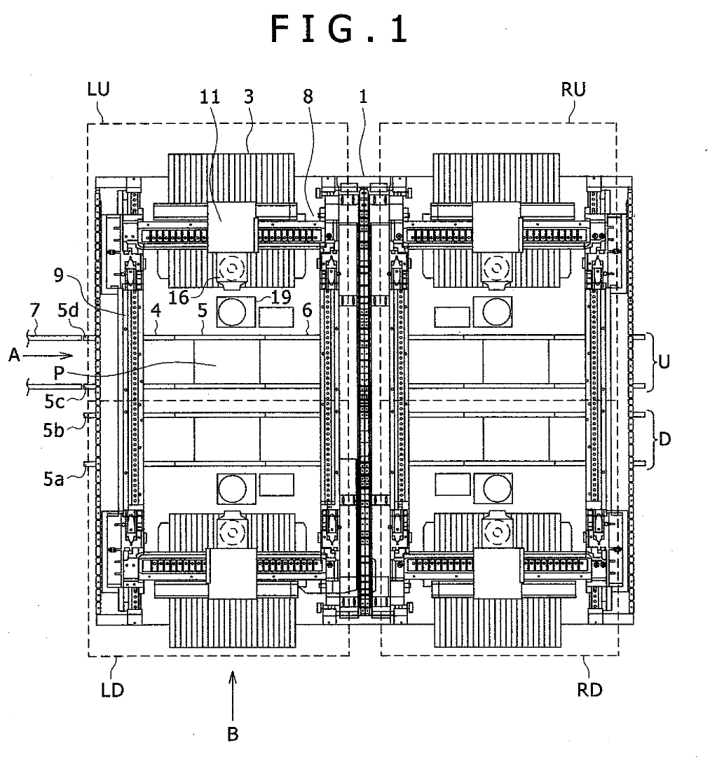

Embodiments of the electronic component mounting apparatus according to the present invention will be described below with reference to drawings. FIG. 1 is a plan view of an electronic component mounting apparatus 1. In the following description made with reference to FIG. 1, the directions, for example, upper, lower, left, right, middle, and vertical are as seen in FIG. 1. The electronic component mounting apparatus 1 has four blocks, i.e. two upper and lower blocks, LU and LD, on the left side and two upper and lower blocks, RU and RD, on the right side (in FIG. 1, reference numerals are assigned, basically, to components of the LU block only). Each of the four blocks includes a component supply area 3 provided with many known tape feeders, a mounting head 16, a mounting head carriage 11 to which the mounting head 16 is fixed and which travels on a laterally extending rail 8 equipped with a linear motor, and a component recognition camera 19 which takes an image of a component held by a suction nozzle of the mounting head 16 to check and correct, as required, the position of the suction nozzle before the component is mounted on a board. The LU and LD on the left side are provided with a pair of rails 9 which are equipped with a linear motor and used to transfer the mounting head carriages 11 for the left-side blocks in the vertical direction. Similarly, the RU and RD on the right side are also provided with a pair of rails 9 equipped with a linear motor. Four chutes 5a, 5b, 5c, and 5d, each for each block, for transferring boards P are provided extending laterally in a middle zone of the electronic component mounting apparatus 1. The two chutes 5c and 5d for the two upper blocks LU and RU make up a board transfer line U for the two upper blocks. The two chutes 5a and 5b for the two lower blocks LD and RD make up a board transfer line D for the two lower blocks. The boards P are each fed from a feed section 7 to either board transfer line U or D.

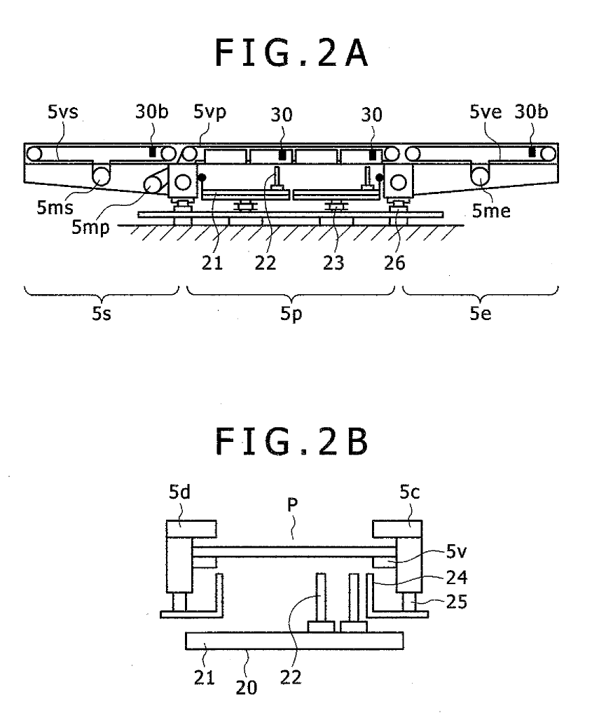

FIGS. 2A and 2B schematically show the configuration of the board transfer lines shown in FIG. 1. FIG. 2A is a side view, as seen in the direction of arrow B of FIG. 1, of each of the chutes 5. FIG. 2B is a simplified side view, as seen in the direction of arrow A of FIG. 1, of a board positioning section 5p, being described later, provided between the chute members 5c and 5d.

Each of the chutes 5 has a board supply section 5s into which a board P is fed, the board positioning section 5p, and a board discharge section 5e. The sections 5s, 5p, and 5e are provided with transfer belts 5vs, 5vp, and 5ve, respectively. The transfer belts 5vs, 5vp, and 5ve are driven, to transfer a board P from an inlet to an outlet of the transfer line, by transfer motors 5ms, 5mp, and 5me provided in the sections 5s, 5p, and 5e, respectively.

The board supply section 5s and the board discharge section 5e are each provided, near an end portion thereof, with a board transfer sensor 30b for detecting a board when it is transferred into a predetermined position. When, for example, a board P is detected by the board transfer sensor 30b provided in the board supply section 5s, it is subsequently transferred to the board positioning section 5p provided that the board positioning section 5p is ready to receive the board P. When the board positioning section 5p is not yet ready, the board P is held ready to be transferred in the board supply section 5s. When a board P is transferred to the board discharge section 5e, it is handled in a similar manner to that described above regarding the board supply section 5s.

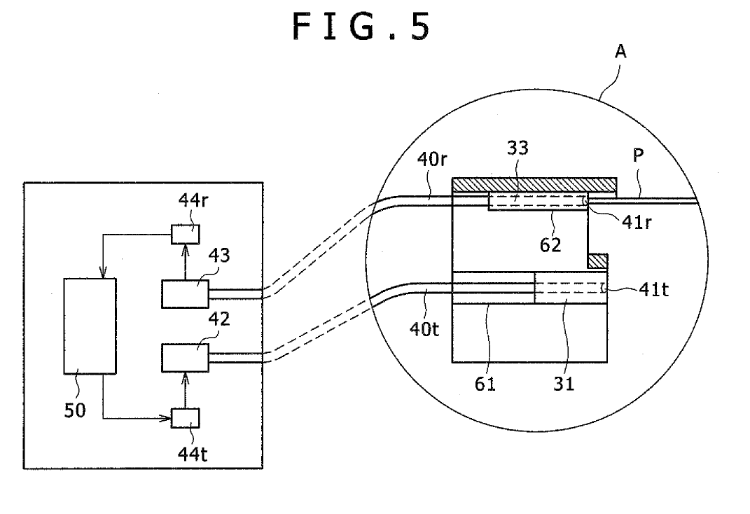

The board positioning section 5p has a board support section 20 which supports a board P when a component is mounted on the board P. The board support section 20 includes a support base 21, support pins 22, cylinders 23, and Z-clamps 24. Referring to FIG. 2B, when a component is mounted on a board P by the mounting head 16, the support base 21 is pushed up above the transfer belt 5vp by the cylinders 23 to be fixed to the chute members 5c and 5d. The support pins 22 prevent, when a component is mounted on the board P, the board P from being bent by the mounting head 16. The board positioning section 5p shown in FIG. 2A allows up to two boards P to be transferred thereinto to have components mounted on them. Hence, the board positioning section 5P is provided with two board position detection sensors 30 each having the function of the board transfer sensor 30b, being described later, and a board positioning detection function used to detect a board correctly positioned to have a component mounted thereon. The board P on which a component is to be mounted is selected by a control section 50 shown in FIG. 5.

When a board P is transferred into the board positioning section 5p, it is detected by one of the board position detection sensors 30 performing board transfer detection. When the board P is detected, the transfer belt 5vp and, hence, the detected board P are stopped. Subsequently, the board P is pushed up by the board support section 20, and the board position detection sensor 30 performs board positioning detection to make sure that the board P has been securely fixed to the chute members 5c and 5d.

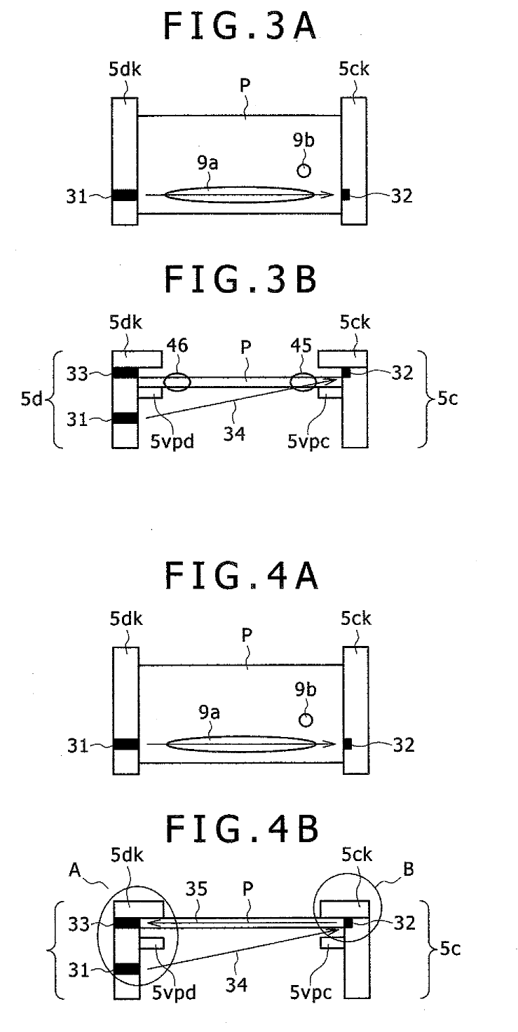

FIGS. 3A, 3B, 4A, and 4B illustrate the board position detection sensor 30. FIGS. 3A and 3B illustrate the configuration and operation of the board position detection sensor 30 performing board transfer detection. FIGS. 4A and 4B illustrate the configuration and operation of the board position detection sensor 30 performing board positioning detection. FIGS. 3A and 4A are each a plan view. FIGS. 3B and 4B are each a simplified side view, like FIG. 2B, of the board positioning section 5p provided between the chute members 5c and 5d as seen in the direction of arrow A of FIG. 1.

The board position detection sensor 30 shown in FIGS. 3A, 3B, 4A, and 4B includes a light transmitting section 31 attached, below a transfer belt 5vpd, to the chute member 5d, an optical repeater section 32 attached to the chute member 5c, paired with the chute member 5d to make up a board transfer line, and positioned between a transfer belt 5vpc and a board guide 5ck provided for the chute member 5c, and a light receiving section 33 attached, like the light transmitting section 31, to the chute member 5d. The light receiving section 33 has a light receiving area ranging between a board guide 5dk provided for the chute member 5d and the transfer belt 5vpd without reaching the upper side of the transfer belt 5vpd. In this configuration, the light transmitting section 31 transmits output light 34 toward the optical repeater section 32. The optical repeater section 32 receives the output light 34 and retransmits the received output light 34 as retransmitted light 35 to the light receiving section 33 attached to the chute member 5d to face the optical repeater section 32. The light receiving section 33 receives the retransmitted light 35.

The board transfer detection and board positioning detection operations performed in the above configuration will be described below. In the board transfer detection operation as illustrated in FIGS. 3A and 3B, the output light 34 crosses, at a location near the optical repeater section 32, an end portion 45 of the board P. In many cases, cutout portions and holes such as 9a and 9b are located in a central portion of the board P with end portions such as 45 and 46 seldom including such cutout portions or holes. The present configuration, therefore, makes it possible to reliably detect, by the board transfer detection operation, the board P transferred into the board positioning section 5p. For the board transfer detection operation, one of the light transmitting section 31 and the optical repeater section 32 is positioned preferably in proximity to the transfer belt 5vpd or 5vpc. Referring to FIG. 3B, the optical repeater section 32 is positioned above the transfer belt 5vpc with the light transmitting section 31 positioned below the transfer belt 5vpd so as to cause the output light 34 to hit the end portion 45 of the board P. In determining the location of the optical repeater section, it is necessary to take into consideration the board position detection operation being described later. When, for example, the optical repeater section 32 is positioned more above the upper surface of the transfer belt 5vpc, the light transmitting section 31 is required to be positioned more below the transfer belt 5vpd. The output light 34 outputted from the light transmitting section 31 is preferably beam-like light. It may be light mostly transmitted onto the end portion 45 of the board P.

Even though, in the present example, the optical repeater section 32 is used, the optical repeater section 32 may be replaced by the light receiving section 33 as far as only the board transfer detection operation is concerned.

Referring to FIG. 4B, for the board positioning detection operation, the light receiving section 33 is positioned to face the optical repeater section 32 and has a light receiving area ranging from the board guide 5dk to the transfer belt 5vpd at the most. The light receiving section 33 can, therefore, detect partial blocking by the board P of the light 35 retransmitted from the optical repeater section 32 to recognize the presence of the board P. When partial blocking of the light 35 retransmitted from the optical repeater section 32 is detected with the support base 21 at rest, the board P can be determined to have been set in a predetermined position. To make positioning of the board P detectable with higher reliability, an arrangement may be made so that, when the board P is correctly positioned, it mostly or completely blocks the retransmitted light 35. For such an arrangement, the light receiving section 33 is required to be positioned as closely as possible to the board guide 5dk of the chute member 5d such that the light receiving surface of the light receiving section 33 is optically shielded by the board P. In this way, the retransmitted light 35 is mostly blocked by the board P, so that the board P can be detected without fail.

Furthermore, the light transmitting surface of the optical repeater section 32 can be positioned as closely as possible to the board guide 5ck so that the light transmitting surface is optically shielded by the board P. In this latter case, compared with the former case with the light transmitting surface of the optical repeater section 32 unshielded, in which the light transmitting surface of the optical repeater section 32 is also shielded, a higher S/N ratio can be obtained to allow the board P to be detected more reliably.

In either case, the above configuration for board positioning detection makes it possible to detect positioning of the board P without fail.

Even though, in the above configuration, the optical repeater section 32 is used, the optical repeater section 32 may be replaced by the light transmitting section 31 as far as only the board positioning detection operation is concerned.

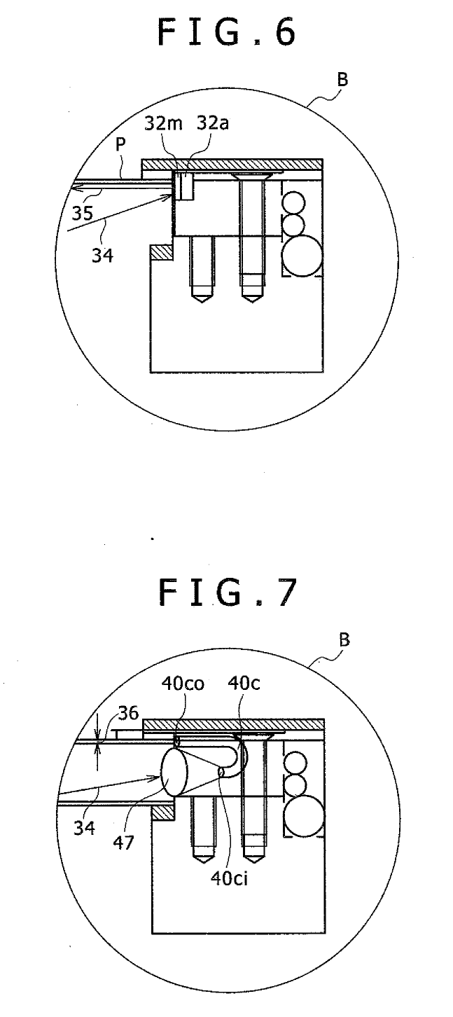

A first embodiment of the present invention will be described with reference to FIG. 4B to FIG. 6. FIG. 5 is an enlarged view of a portion A shown in FIG. 4B. FIG. 6 is an enlarged view of a portion B shown in FIG. 4B.

Referring to FIG. 5, the light transmitting section 31 is connected with an optical fiber bundle 40t including plural optical fibers and fixed to a cutout portion 61 of the chute member 5d; and the light receiving section 33 is connected with an optical fiber bundle 40r including plural optical fibers and fixed to a cutout portion 62 of the chute member 5d. The optical fiber bundle 40t is fitted, at one end, with a microlens 41t; and the optical fiber bundle 40r is fitted, at one end, with a microlens 41r. The other end of the optical fiber bundle 40t is connected to a light emitting device 42. The other end of the optical fiber bundle 40r is connected to a light receiving device 43. The light emitting device 42 and the light receiving device 43 are controlled by the control section 50 via amplifiers 44t and 44r, respectively.

The light transmitting section 31 is positioned right below the transfer belt 5vpd. The output diameter of the light transmitting section 31 depends on the output power of the light emitting device 42. In the present embodiment, the diameter is 1.5 mm. The light receiving section 33 is positioned below the board guide 5dk that can block light coming from the outside. Whereas the light receiving surface of the light receiving section 33 is preferably optically shielded completely by the thickness of the board P being worked on, the diameter of the light receiving surface is determined based on the amount of light it receives when not shielded by the board P. In the present embodiment, the diameter is 1 mm.

Referring to FIG. 6, the optical repeater section 32 includes a special mirror 32a and a protective film 32m covering the front surface of the special mirror 32a. The reflecting surface of the optical repeater section 32 being inside an area extending about 8 mm, i.e. from the board guide 5ck to the transfer belt 5vpc, is as large as 3 mm square measured from the board guide 5ck. The special mirror 32a reflects the light 34 outputted from the light transmitting section 31 to generate reflected light. Some of the reflected light is converged, as retransmitted light, on the light receiving section 33. The special mirror 32a may be, for example, Model 4500 made by Nakane that has on its surface a prism which reflects light into multiple directions.

The control section 50 operating under a higher-level integrated controller (not shown) controls the light transmitting section 31 and the light receiving section 33 and determines whether a board P is present.

According to the above embodiment, an electronic component mounting apparatus can be provided which has board detection means capable of reliably determining presence of a board regardless of whether the board has a cutout portion or a hole and regardless of the color and material of the board.

According to the above embodiment, an electronic component mounting apparatus can be provided which, being free of board detection errors, can contribute toward improving productivity.

A second embodiment of the present invention will be described below with reference to FIG. 7. Even though, in the first embodiment, a special mirror is included in the optical repeater section 32, the optical repeater section of the second embodiment includes a condenser lens 47 and an optical fiber bundle 40c. The condenser lens 47 receives light 34 outputted from the light transmitting section 31 and focuses the received output light 34 on one end 40ci of the optical fiber bundle 40c. The other end 40co of the optical fiber bundle 40c is fitted with a microlens 41c. The optical repeater section 32 retransmits the received output light 34 to the light receiving section 33 as retransmitted light 35 transformed into parallel light by the microlens 41c. The diameter of the microlens 41c, i.e. an output diameter 36 is, as far as board positioning detection is concerned, determined to be such that it is optically shielded completely by the thickness of the board P on which a component is to mounted. In this way, when the board P is positioned, the light directed to the light receiving section 33 is completely blocked by the board P, so that a high S/N ratio is secured for the light receiving section 33 to detect positioning of the board P. The boards P to be transferred, however, vary in thickness. Furthermore, in terms of board transfer detection, it is necessary to secure an adequate received-light amount 37 when no board P is present in a board transfer position. The output diameter of the microlens 41c is therefore determined taking into consideration both the thickness of the board P to be transferred and the received-light amount 37. In the present embodiment, the thickness of the board P to be transferred ranges from 0.3 mm to 5 mm, and the output diameter of the microlens 41c is 1 mm.

According to the second embodiment, too, an electronic component mounting apparatus can be provided which can reliably detect board positioning regardless of whether the board has a cutout portion or a hole and regardless of the color and material of the board to thereby contribute toward productivity improvement.

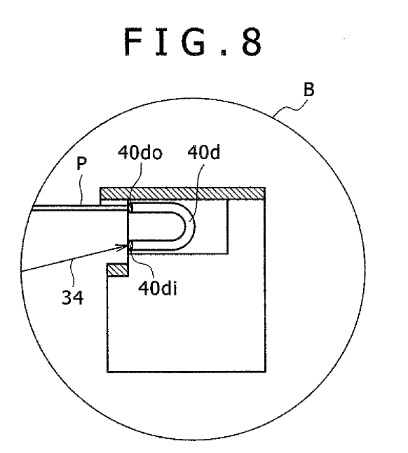

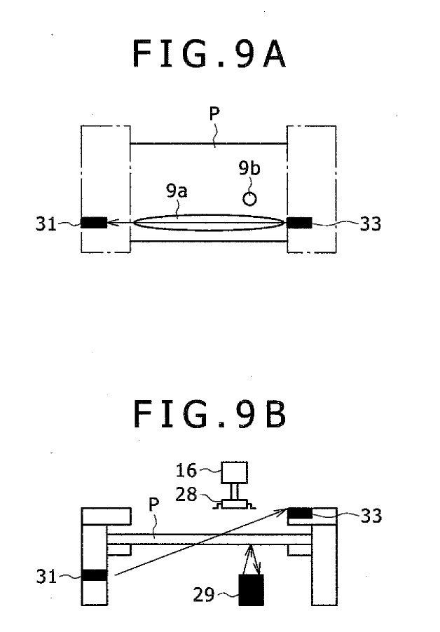

A third embodiment of the present invention is illustrated in FIG. 8. Even though, in the first embodiment, a special mirror is included in the optical repeater section 32, the optical repeater section 32 of the third embodiment includes an optical fiber bundle 40d. The optical fiber bundle 40d is fitted, at both ends thereof, with microlenses 41di and 41do, respectively. The microlens 41di receives the output light 34 from the light transmitting section 31. The received output light 34 is retransmitted as parallel light through the microlens 41do to the light receiving section 33. The consideration made regarding the output diameter of the microlens 41do is the same as described above for the second embodiment.

According to the third embodiment, too, an electronic component mounting apparatus can be provided which can reliably detect board positioning regardless of whether the board has a cutout portion or a hole and regardless of the color and material of the board to thereby contribute toward productivity improvement.

The electronic component mounting apparatus for mounting an electronic component on a printed board has been described above. The portion of the apparatus for detecting a board P being transferred can be used, when the optical repeater section is replaced by a light receiving section, as a board transfer sensor 30b in a board processing apparatus which transfers boards, for example, for an adhesive application system.

Using, as described above, the portion for detecting a board P being transferred as a board transfer sensor 30b makes it possible to provide an electronic component mounting apparatus and a board processing apparatus which can reliably detect a transferred board to thereby contribute toward productivity improvement.

As described above, according to the present invention, an electronic component mounting apparatus can be provided which can reliably detect board positioning regardless of whether the board has a cutout portion or a hole and regardless of the color and material of the board to thereby contribute toward productivity improvement.

Also, according to the present invention, an electronic component mounting apparatus and a board processing apparatus can be provided which can reliably detect a transferred board regardless of whether the board has a cutout portion or a hole and regardless of the color and material of the board to thereby contribute toward productivity improvement.

Although the preferred embodiments of the present invention have been described above, the invention is not to be limited to the above embodiments. Apparently, various modifications and alterations of the invention will occur to those skilled in the art without departing from the scope of the invention.

What is claimed is:

1. An electronic component mounting apparatus comprising a printed board detection unit which detects that a printed board has been transferred, by a pair of transfer parts provided along both side end portions thereof, to a predetermined position and that the printed board has been set in a component mounting position for having an electronic component mounted thereon,
wherein the printed board detection unit includes a light transmitting section which transmits light, a light receiving section which receives light, and an optical repeater section which is positioned to face, across the printed board, the light transmitting section and the light receiving section and which retransmits the light received from the light transmitting section, either the light transmitting section or the light receiving section and the optical repeater section being positioned between the component mounting position and the position to which the printed board is transferred.

2. The electronic component mounting apparatus according to claim 1, wherein the light emitting section is provided below the transfer parts.

3. The electronic component mounting apparatus according to claim 1, wherein the optical repeater section and the light receiving section are positioned between the component mounting position and the position to which the printed board is transferred.

4. The electronic component mounting apparatus according to claim 1, wherein the optical repeater section includes an optical retransmission unit which retransmits the received light to the light receiving section.

5. The electronic component mounting apparatus according to claim 4, wherein the optical retransmission unit includes a reflecting mirror having a prism provided on a surface thereof, the prism reflecting light into multiple directions.

6. The electronic component mounting apparatus according to claim 4, wherein the optical retransmission unit includes an optical fiber bundle having a plurality of optical fibers, a first end of the optical fiber bundle forming a surface for receiving the transmitted light, a second end of the optical fiber bundle forming a surface for outputting light to the light receiving section.

7. The electronic component mounting apparatus according to claim 4, wherein the optical retransmission unit includes an optical fiber bundle having a plurality of optical fibers and a condenser lens which receives and condenses the transmitted light, a first end of the optical fiber bundle forming a surface disposed where the received light is condensed, a second end of the optical fiber bundle forming a surface for outputting light to the light receiving section.

8. The electronic component mounting apparatus according to claim 7, wherein the retransmitted light is parallel light.

9. An electronic component mounting apparatus comprising a printed board detection unit which detects that a printed board has been transferred, by a pair of transfer parts provided along both side end portions thereof, to a predetermined position and that the transferred printed board has been set in a component mounting position for having an electronic component mounted thereon,
wherein the printed board detection unit includes a light transmitting section which transmits light, a light receiving section which receives light, and an optical repeater section which is positioned to face, across the printed board, the light transmitting section and the light receiving section and which retransmits the light received from the light transmitting section; and
wherein, when the printed board is in the predetermined position, the transmitted light crosses an end portion of the printed board and, when the printed board is set in a component mounting position for having an electronic component mounted thereon, the light retransmitted by the optical repeater section is blocked by the printed board.

10. An electronic component mounting apparatus having a printed board positioning detection unit which detects that a transferred printed board has been set in a component mounting position for having an electronic component mounted thereon,
wherein the printed board positioning detection unit includes a light transmitting section which transmits light and a light receiving section positioned to face, across the printed board, the light transmitting section, the light transmitting section and the light receiving section being provided in an area between the component mounting position and a surface over which the printed board is transferred.

11. The electronic component mounting apparatus according to claim 1, wherein the light receiving section is provided at the component mounting position.

12. The electronic component mounting apparatus according to claim 9, wherein the light receiving section is provided at the component mounting position.

13. The electronic component mounting apparatus according to claim 10, wherein the light receiving section is provided at the component mounting position.

14. The electronic component mounting apparatus according to claim 4, wherein the light receiving section has an input diameter determined based on a thickness of the printed board.

15. The electronic component mounting apparatus according to claim 12, wherein the light receiving section has an input diameter determined based on a thickness of the printed board.

16. The electronic component mounting apparatus according to claim 13, wherein the light receiving section has an input diameter determined based on a thickness of the printed board.

17. The electronic component mounting apparatus according to claim 14, wherein the input diameter determined based on the thickness equals a maximum thickness of the printed board set in the component mounting position.

18. A printed board processing apparatus comprising a detection unit which detects that a printed board has been transferred, by a pair of transfer parts provided along both side end portions thereof, to a predetermined position, wherein the detection unit includes a light transmitting section which transmits light and a light receiving section which receives light, the light receiving section being positioned to face, across the printed board, the light transmitting section such that light transmitted from the light transmitting section crosses an end portion of the printed board.

19. The printed board processing apparatus according to claim 18, wherein the printed board is one on which an electronic component is to be mounted.

20. The printed board processing apparatus according to claim 19, wherein at least one of the light transmitting section and the light receiving section is positioned adjacently to a lower side of a first end portion of the transferred printed board, the other section being positioned spacedly from a second end portion of the printed board.
